(19) United States
(12) Patent Application Publication
(10) Pub. No.: US 2003/0030559 A1
(43) Pub. Date: Feb. 13, 2003

(54) Identification or securing of optical discs

(76) Inventors: Daren James Fitzgerald, Surrey (GB); Mark Daniel Krom, London (GB)

Correspondence Address: NIXON & VANDERHYE P.C., 8th Floor, 1100 North Glebe Road, Arlington, VA, 22201, US

(21) Appl. No.: 10/203,000

(22) Filed: Jul. 25, 2002

(30) Foreign Application Priority Data
Jul. 25, 2001 (GB) 0118162.7

(51) Int. Cl. G08B 13/14

(52) U.S. Cl. 340/572.8

(57) ABSTRACT

A cover of a plastics material is adhered to the operative surface of a CD or other optical disc to protect that disc surface. The cover is of substantially the same peripheral shape and size as the surface of the disc on which it is affixed. A security tag is adhered onto the outer surface of the cover and is thus held onto the surface of the disc. The security tag may be detectable by external means, for example, at the exit of a premises, whereby a warning is provided if there is an attempt to remove the disc from the premises. The cover may be removable so that both the cover and tag may be removed in order to play the disc.

### BACKGROUND TO THE INVENTION

The present invention relates to a method of identifying or securing an optical disc and to an optical disc when identified or secured.

If products, such as CDs or DVDs, are on open display in a retail store or in a rental outlet, without any security measures being taken, they can be and often are, stolen. Many large stores, therefore, affix to most or all of their products an externally detectable security device. When a product is purchased the security device is deactivated or detached at the point of purchase. If an attempt is made to steal the product, detectors placed at exits to the premises sound an alarm. U.S. Pat. No. 5,081,446 shows an example of a security device provided in a CD case. Despite these precautions, it is still not advisable to display CDs or DVDs in their cases without further measures being taken as there is the risk that the disc will be removed from the case which is left on display.

Thus, retail outlets which use security devices which are externally detectable generally additionally hold the case of a CD or DVD closed so that the contents cannot be removed. Commonly, the disc case is held closed by a keeper, by shrink wrapping, or by a fastener. Such a fastener may be, for example, a label which may incorporate the security device itself as shown in U.S. Pat. No. 5,984,388.

It will be appreciated that where an outlet decides to secure the disc in its case, and then to attach an externally detectable security device to it, staff, either in the store or of the supplier, have to spend time preparing stock for display. Such security measures are also not useful to those who rent out DVDs, for example, and in such environments it is normally necessary to remove the optical disc from its case so that only the case is placed on display. This then requires staff to retrieve the appropriate disc for the empty case when a customer requires to rent a disc.

It is also known to provide protective covers for compact discs to protect them against scratching. Such covers, which are generally intended to be permanently applied, are disclosed in EP 0803121 and EP 0998743.

### SUMMARY OF THE INVENTION

The present invention seeks to provide improvements to the security of optical discs.

According to a first aspect of the present invention there is provided an optical disc provided with identification or security means, said identification or security means comprising a cover held on one surface of the optical disc, and a security or identification tag applied to said one surface of the optical disc by said cover.

In an embodiment of the present invention, a security or identification tag has been applied, by way of the cover, to one surface of the optical disc itself. An embodiment of the invention, therefore, secures the optical disc itself rather than its packaging. The cover may be applied to either surface of the optical disc.

It would be possible for some players of optical discs to reliably play a disc on which a security or identification tag remains applied. In such circumstances, therefore, the cover would remain applied to said one surface. However, it is generally preferred that the tag be removed from the optical disc before it is used in a player. Thus, it is presently preferred that the cover is removable.

In an embodiment, the cover is similar in peripheral shape and size to the one surface of the optical disc. The cover may be a sheet or film of a suitable material, for example, a sheet or film of a plastics material.

An optical disc such as a CD or DVD has an operative surface on which the spiral track is provided and on which laser light is impinged to obtain data from the disc. The opposite, planar surface of the optical disc will frequently have a label provided thereon. A cover to be used in an embodiment of the invention may be held on either the operative or inoperative surface of the optical disc, or a respective cover may be provided on each surface of the optical disc.

Recently, it has been proposed to provide a protective layer for the operative surface of CDs. The proposed layer is of a plastics material which is intended to be applied against the operative surface of the CD before its first use to provide protection to that surface against scratches and other damage. The protective layer is of a clear thin plastics material which is smoothed onto the operative surface so that it follows the contours thereof and enables data to be obtained from the operative surface of the disc. Although such protective layers are intended to be applied permanently to the operative surface of the disc, the applicants believe that such a commercially available protective layer can be used in an embodiment of the invention if it is ensured that the adhesive used to hold the known protective layer to the disc is made to be removable.

In this respect, whilst there are many players which could satisfactorily play a CD, for example, with a security or identification tag affixed thereto, there are some circumstances where its weight, or the electrical or magnetic characteristics of such a tag would interfere with play of the disc. There are also disc players in which any disc carrying a tag would be unplayable because of the increased volume of a disc carrying the tag.

It is possible to hold the security or identification tag in position on the one surface of the disc by sandwiching it between the cover and the disc. In a preferred embodiment, the security or identification tag is applied to the cover, for example, is adhered to the cover. Where the tag is adhered to the cover, the tag will generally be on the outwardly facing surface of the cover.

As indicated, it is presently preferred that the cover be held in a releasable manner to the one surface of the optical disc. The cover may be held in place, for example, by a removable or peelable adhesive, by the use of static, or by mechanical means. Any of these holding means may be used alone or in combination with any one or more of the other holding means.

Where the cover is held by a releasable adhesive or clung by a static effect, it may be advisable to include tabs or cut outs on the cover to facilitate grasping of the cover to enable its easy removal.

A cover may be mechanically held to one surface of an optical disc in a variety of manners. For example, one or more peripheral extensions or tabs may be extended from the outer periphery of the cover and bent over the periphery of the disc to retain the cover in position. These tabs may, in a preferred embodiment, be adhered to the surface of the optical disc opposed to said one surface.

Other mechanical retention means are possible. For example, mechanical means which extend through the aperture at the centre of the disc may be used alone or in conjunction with other means.

In one preferred embodiment, a respective cover is applied to each of the two surfaces of the optical disc, the two covers being fastened together to produce a package in intimate contact with the disc.

In a preferred embodiment, one or more tabs are extended from the periphery of the cover and are arranged to retain an optical disc in its case. For example, a tab may be retained by structures within the case and/or may be adhered thereto.

The nature of the security or identification tag may be chosen as is required. Where the tag is provided for identification purposes, for example, the tag may be a simple label or may carry a bar code or hologram. The tag may alternatively be an intelligent tag. For example, intelligent tags may be utilised to automate inventory management tasks. In a presently preferred embodiment, the tag is a security tag which is detectable by external means. The tag may be detectable, for example, by article surveillance devices, such as electronic audible surveillance devices, or by electrical or magnetic means which may include, for example, radio frequency, electromagnetic or acoustomagnetic detectors.

The present invention also extends to a method of identifying or securing an optical disc, the method comprising holding a cover to one surface of the optical disc, and applying a security or identification tag to said one surface of the optical disc by the cover.

In an embodiment of the present invention, a security or identification tag is applied, by way of the cover, to one surface of the optical disc itself. A method of the invention, therefore, enables the optical disc itself to be secured rather than its packaging.

Preferably, the cover is removable.

In an embodiment, the cover is similar in peripheral shape and size to the one surface of the optical disc. The cover may be a sheet or film of a suitable material, for example, a sheet or film of a plastics material.

An optical disc of the invention may have a cover held on its operative or on its inoperative surface. In an alternative embodiment, a respective cover may be provided on each surface of the optical disc.

It is possible for the security or identification tag to be held on the one surface of the disc by sandwiching it between the cover and the disc.

In a preferred embodiment, the security or identification tag is applied to the cover, for example, is adhered to the cover. In this case, the tag is preferably applied to the outwardly facing surface of the cover.

Preferably, the cover is held in a releasable manner to the one surface of the optical disc. The cover may be held in place, for example, by a removable or peelable adhesive, by the use of static, or by mechanical means. Any of these holding means may be used alone or in combination with any of the other holding means.

Where the cover is held by a releasable adhesive or clung by a static effect, tabs and/or cut outs are provided on the cover to facilitate grasping of the cover to enable its easy removal.

A cover may be mechanically held to one surface of an optical disc by a number of means. For example, one or more peripheral extensions or tabs may be extended from the outer periphery of the cover and bent over the periphery of the disc to retain the cover in position. These tabs may, in a preferred embodiment, be adhered to the opposite surface of the optical disc.

Other mechanical retention means are possible. For example, mechanical means which extend through the aperture at the centre of the disc may be used alone or in conjunction with other means.

In a preferred embodiment, a respective cover is applied to each of the two opposed surfaces of the optical disc, the two covers being fastened together to produce a package in intimate contact with the disc.

In a preferred embodiment, one or more tabs are extended from the periphery of the cover and are used to retain the optical disc in a case therefor. For example, a tab may be retained by structures within the case and/or may be adhered thereto.

The nature of the security or identification tag may be chosen as is required. For identification purposes, for example, the tag may be a simple label or may carry a bar code or hologram. In a presently preferred embodiment, the tag is a security tag which is detectable by external means. The tag may be detectable, for example, by article surveillance devices or by electrical or magnetic means which may comprise radio frequency, electromagnetic or acoustomagnetic detectors.

### BRIEF DESCRIPTION OF THE DRAWINGS

Embodiments of the present invention will hereinafter be described, by way of example, with reference to the accompanying drawings, in which:

FIG. 1 shows an optical disc provided with security means in accordance with a first embodiment of the present invention;

FIG. 2 shows an optical disc provided with security means according to a second embodiment of the invention; and

FIG. 3 shows an optical disc provided with security means according to a third embodiment of the invention.

### DESCRIPTION OF PREFERRED EMBODIMENTS

The invention is described hereinbelow with specific reference to a CD. However, it will be appreciated that the invention is applicable to optical discs in general irrespective of their size or format. Furthermore, the invention will now be described with specific reference to a security tag detectable by external means. However, and as explained previously, the tag which is applied to the optical disc may be a passive identification tag, an active security tag, or some composite having both active and passive functions. In this respect, a passive tag will generally be discerned solely by visual means whereas a tag having an active function will interact with external means.

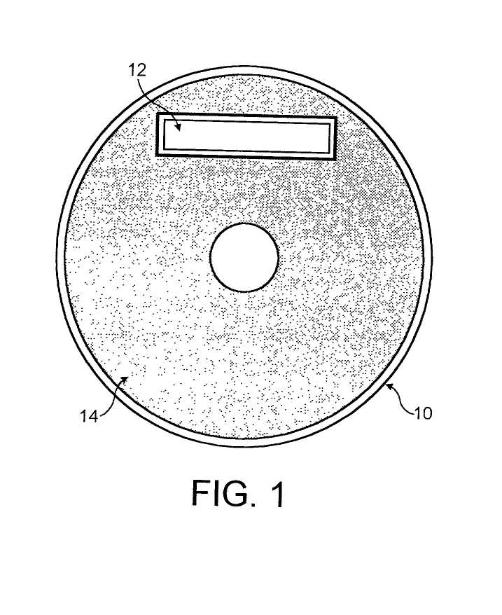

FIG. 1 shows a CD 10 having a security tag 12 held on one surface thereof by way of a cover 14. In this respect, the security tag 12 is adhered to the outwardly facing surface of the cover 14. The inner surface of the cover 14 is adhered to one of the surfaces of the compact disc 10. Thus, the cover 14 holds the security tag in position on the disc 10.

The cover 14 has the same peripheral shape and substantially the same size as the surface of the disc 10 on which it is affixed. Preferably, the cover 14 is adhered to the surface of the CD, but the adhesive is chosen to be releasable or peelable whereby the cover may be removed. As it may be preferred to fix the cover 14 onto the operative surface of the CD 10, it is important that the adhesive not leave residues on the CD after its removal.

In use, for example, in an establishment where CDs are rented out, the staff would adhere a cover as 14 onto the operative surface of a CD and then adhere a security tag 12 thereto. The cover would thus protect the operative surface of the CD against scratches and mishandling and the security tag 12 would provide security for the CD itself. Thus, if someone tried to remove the CD from the premises, external means at the exit of the premises would be activated by the security tag. Each CD can thus be housed in its normal case and put on open display.

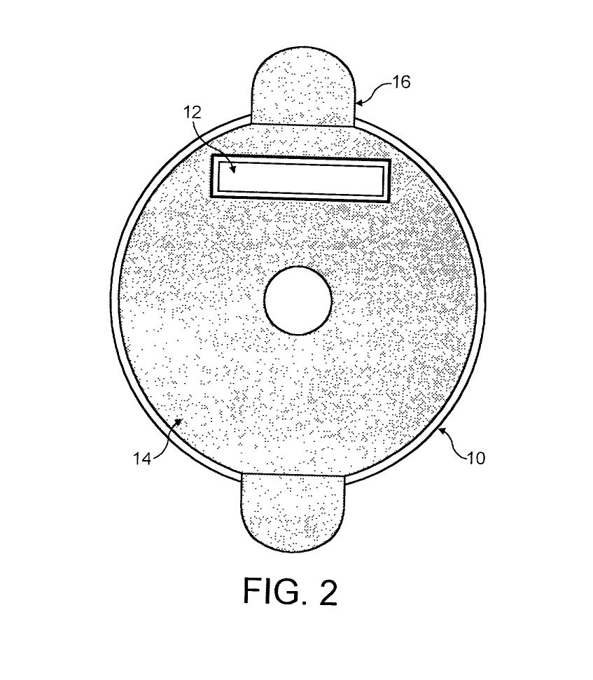

When a customer rents the CD, for example, a staff member either removes the security tag, by removing the protective cover 14, or deactivates the tag. In the second case, the customer then needs to remove the cover 14 before playing the CD.

Where the cover 14 is adhered to the CD 10, an embodiment as shown in FIG. 1 might present difficulties when the cover 14 is to be removed to use the disc. Such difficulties could be overcome by an arrangement as shown, for example, in FIG. 2. In the embodiment of FIG. 2, two opposed tabs 16 extend from the periphery of the cover 14. In this respect, it will be appreciated that the number of tabs 16 and their mutual arrangement can be chosen as required. These tabs 16 are easy to grasp and thereby facilitate removal of the cover 14 from the disc 10.

However, in a preferred embodiment, the tabs 16 may be used not only to make the removal of the cover 14 simpler, but also to keep the CD in position in its case and/or to hold the cover 14 in position.

For example, the tabs 16 may have adhesive provided on at least one of their surfaces. The adhesive may be used to secure the tabs 16 to interior surfaces of a case in which the disc 10 is housed. Additionally and/or alternatively, the tabs 16 may be bent around the periphery of the disc 10 either to act as the means holding the cover 14 in position or to assist in the holding of the cover.

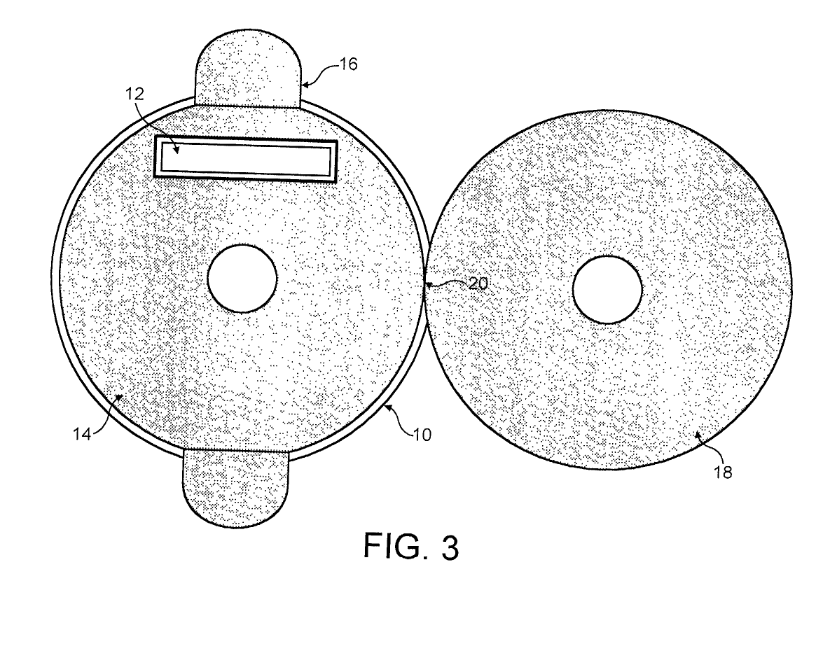

In the embodiment of FIG. 3, two covers 14 and 18 are provided which are connected together at a tangential area 20. It will be immediately appreciated that if the two covers 14 and 18 are applied against opposed surfaces of a CD, they will tend to hold the CD within the two covers 14, 18. Where tabs 16 are additionally provided, a purely mechanical pouch can be formed by the adherence of the tabs 16 on the first cover 14 to the second cover 18 when in its folded position.

It will be appreciated that other modifications and/or variations to the illustrated embodiments may be made within the scope of this application.

1. An optical disc having a first generally planar surface, and a second generally planar surface, and wherein the optical disc has an identification or security device, said identification or security device comprising a generally planar cover held on the first planar surface of the optical disc, and a security or identification tag applied to said first surface and held relative to said first surface by said cover.

2. An optical disc according to claim 1, wherein the cover is removable.

3. An optical disc according to claim 1, wherein the cover is similar in peripheral shape and size to said first surface of the optical disc.

4. An optical disc according to claim 1, wherein the cover is a sheet or film of a suitable material, for example, a sheet or film of a plastics material.

5. An optical disc having a first generally planar surface, and a second generally planar surface, and wherein the optical disc has an identification or security device, said identification or security device comprising a generally planar cover held on the first planar surface of the optical disc, and a security or identification tag applied to said first surface and held relative to said first surface by said cover, wherein the cover is removable, and wherein the cover is a sheet or film of plastics material.

6. An optical disc according to claim 1 or claim 5, wherein the first surface of the optical disc is the operative surface thereof whereby the cover is held on the operative surface of the optical disc.

7. An optical disc according to claim 1 or claim 5, wherein the first surface of the optical disc is the inoperative surface whereby the cover is held on the inoperative surface of the optical disc.

8. An optical disc according to claim 1 or claim 5, wherein there are two covers, and a first cover is provided on the first surface of the optical disc and the second cover is provided on the second surface of the optical disc.

9. An optical disc according to claim 1 or claim 5, wherein the security or identification tag is held on the one surface of the disc by sandwiching it between the cover and the disc.

10. An optical disc according to claim 1 or claim 5, wherein the security or identification tag is adhered to the cover.

11. An optical disc according to claim 5, wherein the security or identification tag is adhered to the cover, and wherein the tag is applied to the outwardly facing surface of the cover.

12. An optical disc according to claim 1, wherein the cover is held in a releasable manner to the first surface of the optical disc.

13. An optical disc according to claim 12, wherein the cover is held in place by a removable or peelable adhesive.

14. An optical disc according to claim 12 or claim 13, wherein the cover is held in place by the use of static.

15. An optical disc according to claim 12 or claim 13, wherein the cover is held in place by mechanical means.

16. An optical disc according to claim 12, wherein the cover is held in place by mechanical means and wherein one or more peripheral extensions or tabs are extended from the outer periphery of the cover and have been bent over the periphery of the disc to retain the cover in position.

17. An optical disc according to claim 16, wherein said tabs are adhered to the second surface of the optical disc.

18. An optical disc according to claim 1 or claim 5, further comprising tabs and/or cut outs provided on the cover to facilitate grasping of the cover to enable its easy removal.

19. An optical disc according to claim 1 or claim 5, wherein one or more tabs are extended from the periphery of the cover and are used to retain the optical disc in a case.

20. An optical disc according to claim 1 or claim 5, wherein there are first and second covers, and the first cover is applied to the first surface of the optical disc, and the second cover is applied to the second surface of the optical disc, and wherein the first and second covers are fastened together to produce a package in intimate contact with the disc.

21. An optical according to claim 1 or claim 5, wherein the tag is a security tag which is detectable by external means.

22. A method of identifying or securing an optical disc, the optical disc having a first generally planar surface, and a second generally planar surface, the method comprising holding a generally planar cover on the first planar surface of the optical disc, and utilising the cover to apply a security or identification tag to said first planar surface of the optical disc.

23. A method of identifying or securing an optical disc according to claim 22, wherein the cover is removable.

24. A method of identifying or securing an optical disc according to claim 22 or claim 23, wherein the cover is similar in peripheral shape and size to the first surface of the optical disc.

25. A method of identifying or securing an optical disc according to claim 22 or claim 23, wherein the cover is a sheet or film of a suitable material, for example, a sheet or film of a plastics material.

26. A method of identifying or securing an optical disc according to claim 22, wherein the first surface of the optical disc on which the cover is held is either the operative or the inoperative surface of the optical disc.

27. A method of identifying or securing an optical disc according to claim 22, comprising removably adhering the cover to said first surface of the optical disc, and adhering the security or identification tag onto the outwardly facing surface of the cover.
